(19) United States
(12) Patent Application Publication
(10) Pub. No.: US 2014/0067111 A1
(43) Pub. Date: Mar. 6, 2014

(54) METHOD AND CONTROL DEVICE FOR THE LOW-VIBRATIONAL MOVEMENT OF A MOVEABLE CRANE ELEMENT IN A CRANE SYSTEM

(71) Applicant: Michael Vitovsky, Seligenstadt (DE)

(72) Inventor: Michael Vitovsky, Seligenstadt (DE)

(21) Appl. No.: 14/003,043

(22) PCT Filed: Mar. 5, 2012
(86) PCT No.: PCT/EP12/53753

§ 371 Date: Oct. 3, 2013

(30) Foreign Application Priority Data
Mar. 4, 2011 (DE) 11 001 112.9

(51) Int. Cl. B66C 13/18

(52) U.S. Cl. CPC B66C 13/18
USPC 700/228

(57) ABSTRACT

The invention relates to a method and a control device for the low-vibrational control of the movement, by means of a motor (20), of a movable crane element (14, 16, 18) such as a crane jib (18) in a crane system (10), said crane element being made to vibrate at a natural frequency (f_{EIG}) and having a damping ratio (ζ). Said movable crane element (14, 16, 18) is controlled by a control signal (V_{SOLL}), the spectrum of which is substantially free from natural frequencies (f_{EIG}) of the crane system (10), and the control signal (V_{SOLL}) is calculated from an operator signal (S_{BED}) of an operator, taking into account system parameters of the crane system (10). So as to reduce vibrations in a rotating tower crane structure during the pivoting movement and to simplify configuration of the control device in a method and control device of the type referred to initially, the system parameters in the form of the natural frequency (f_{EIG}) and the damping ratio (ζ) of the crane system (10) are automatically calculated during operation, and the control signal (V_{SOLL}) is calculated in real-time, as an active speed-reference profile (V_{SOLL}), from the operator signal (S_{BED}) of the operator as well as from the calculated natural frequency (f_{EIG}) and the damping ratio (ζ) of the crane system (10).

The invention relates to a method for the low-vibrational control of the movement, by means of a motor, of a moveable crane element such as a crane jib in a crane system, said crane element being made to vibrate at a natural frequency and having a damping ratio, wherein the moveable crane element is controlled by a control signal whose spectrum is substantially free of natural frequencies of the crane system, wherein the control signal is calculated from an operator signal of an operator, taking into account system parameters of the crane system, as well as to a control device for the low-vibrational control of the movement of a moveable crane element such as a crane jib of a crane system, which is made to vibrate at a natural frequency and has a damping ratio, wherein the moveable crane element can be controlled by means of a control signal whose spectrum is essentially free of the natural frequency, wherein the control signal is calculated in a set value calculation unit from an operator signal of an operator taking into account system parameters, and wherein the control system applied at the outlet of the set value calculation unit is fed to a motor control for controlling the motor.

The method and the control device of the type mentioned at the start are described in DE-A-10 2004 052 616. The method is used to control the movement of a moveable crane element of a crane system, wherein at least some portions of the crane system can be made to vibrate in a pendulum swing motion. Here, the crane system has at least one natural frequency, which can be changed by the movement of the moveable crane element. Using a control circuit, a control signal is generated which actuates a drive unit of the crane system for the movement of the moveable crane element, for example, in the form of a traveling trolley. In the process, the control signal is generated substantially without the natural frequency of the pendulum swing of the crane system, so that there is no excitation of the pendulum swing motion, to the extent possible.

The energy which is stored in a flexible structure of a rotating tower crane, during the acceleration and the deceleration of pivoting movements, causes vibrations in the structure. These vibrations that are superposed on the pivoting speed of the crane jib are perceived by a crane operator as an unstable speed of the jib end. Such a behavior makes it difficult to control the crane; in particular it makes it difficult to achieve precise positioning and manual control of the pivoting movement at a low pivoting speed.

A rotating tower crane behaves as a spring during the pivoting movement. The energy delivered by the engine results in torsion of the tower and of the jib. The energy stored in the mechanical system causes vibrations of the structure, as shown in FIG. 1b.

Various possibilities exist for handling vibrations caused by a pivoting movement.

Drive units without frequency converter:
fluid coupling (indirect coupling between a motor and a pivot shaft)
eddy current brake, wherein the braking moment is applied by means of an eddy current brake,

Drive units with frequency converter:
V/f motor control mode (soft motor control mode, the motor speed is influenced by the torque),
limiting the generator torque (the motor speed is influenced by the torque, if it is within the generator quadrant).

Using the above-listed possibilities, the aim to be achieved is to reduce the force that is the primary cause of the vibrations. However, this means that the speed of the drive motor or of the drive shaft is influenced by the torque resulting from the vibrations in the structure.

None of the proposed passive solutions is optimal, since they sacrifice reactivity in order to reduce the vibrations.

Furthermore, methods are known in which the active generation of a speed profile is used, such as, for example, the “Posicat” control of O. J. M. Smith and the input shaping of N. C. Singer, W. E. Singose and W. P. Seering or T. Sing et al., “Tutorial on input shaping/time delay control of maneuvering flexible structures, N. Singer: An input shaping controller enabling cranes to move about sway,” to whose content reference is made hereby.

The above papers relate, however, to pendulum movements of loads suspended on a crane jib.

DE 41 30 970 A1 discloses a control system for an electric motor which drives a hoisting drum of a mining pit wench or of a conveyor system, which comprises a transport means supported by a rope and forms a vibrating system. The control system has a load sensor for monitoring the loading of the rope, a rope length sensor for monitoring the rope length paid out of the hoisting drum, a motor control unit reacting to signals of the sensors, which calculates the set values for the rpm, the acceleration and the compressive movement of the vibrating system. The control unit generates a control signal which is set in a relation relative to a natural frequency characteristic of the vibrating system, in order to prevent the generation of vibrations in the system, and it controls a motor drive device in accordance with the control signal. As a result, a control system for the normal operation and for emergency braking processes is to be provided, which reduces the vibrations in the longitudinal direction.

In DE 10 2006 048 988 A1, a control system for a jib crane having a tower and a jib pivotably attached to the tower is described. The jib crane comprises a first actuator for generating a rocking movement of the jib, a second actuator for turning the tower, a first means for determining the position and/or the speed of the jib head by measurements, a second means for determining the rotation angle and/or the rotation speed of the tower by measurement, wherein the control system controls the first and the second actuators. In the process, the acceleration of the load in the radial direction due to a rotation of the crane caused by a rocking movement of the jib is compensated for as a function of the rotation speed of the tower determined by the second means. A control system for a jib crane is to be provided, which has a better precision and in particular which leads to a better control of the damping of the pendulum movement of the load.

DE 10 2009 032 270 A1 relates to a method for controlling a drive unit of a crane. Here, a target movement of the jib tip is used as input variable, on the basis of which a control variable for controlling the drive unit is calculated. In order to make available a control of a drive unit of a crane, which decreases vibration-caused loading of the crane structure, it is provided that, in the calculation of the control variable, the vibration dynamics of the system of the drive unit and its crane structure is taken into account in order to reduce the natural frequencies. The calculation of the control variable is made on the basis of a mathematical model of the crane structure. The development and the calculation of the mathematical model are associated with great expense.

DD 260 052 relates to a control of the movement processes for resilient carriage drives with backlash of cranes, particularly for those in which, due to backlash in the drive unit or due to the resilience of the supporting structure, undesired vibrational stresses occur during startup and braking. The purpose of such a control is to automatically control, in the case of drive units of resilient crane constructions or in those with backlash, the movement processes, in such a manner that undesired vibrational stresses of the supporting structure and the drive unit are prevented. As advantage, it is indicated that the stress reduction results in a reduction of the down times of the crane caused by the destruction of component groups of the drive units or of the supporting structure due to excess stress, and in a reduction of the time it takes for the carriage to slow down at the target point.

Based on the above, the aim of the present invention is to further develop a method and a control device of the type mentioned at the start in such a manner that the vibrations in the structure of a rotating tower crane during the pivoting movement are reduced, and the configuration of the control device is simplified.

The aim is achieved according to the invention in that the system parameters are calculated automatically in the form of the natural frequency as well as the damping ratio of the crane system during the operation, and in that the control signal is calculated as an active speed reference profile in real time from the operator signal of the operator and from the calculated natural frequency and the damping ratio of the crane system.

The method according to the invention uses an automatically generated speed reference profile for the drive motor, such as a swivel motor, in order to suppress vibrations at the natural frequency of the structure of the crane system.

The method is implemented as an open loop control method. The modified speed reference profile is calculated in real time from control commands or operator signals of an operator, from the natural frequency of the system, and from its damping ratio.

These parameters are calculated using an automatic identification and configuration algorithm.

In comparison to the prior art, the method is characterized in that a mathematical model of the crane structure is not absolutely necessary.

A particularly preferred method, which is used for the automatic calculation of parameters, is based on values of the actual motor torque and/or motor current, which are determined at a motor control with variable speed. The value of the motor torque/motor current varies at the same frequency as that at which the mechanical structure of the crane vibrates. Therefore, it is possible to derive parameters of the crane structure using a sampled torque profile. It is preferable to calculate the natural frequency f_{EIG} and the damping ratio (ζ) of the crane element from the measured current and/or torque of the motor.

A preferred auto-configuration method for a rotating tower crane comprises the following process steps:

a) executing a first movement of the moveable crane element by acceleration by means of a freely selectable speed profile, such as an acceleration ramp with linear course, which is sufficiently steep to make the crane system vibrate,

b) sampling the torque values and/or current values,

c) performing a spectral analysis, preferably by fast Fourier transform, with the determined torque and/or current values, and determining a spectral distribution,

d) identifying a dominant frequency of the spectral distribution as the natural frequency of the crane system, and

e) calculating the damping ratio from initially sampled current values and/or torque values.

It is preferable to repeat the process steps regularly with the acceleration ramp determined in the respective previous cycle.

The sampling of the current values and/or torque values occurs after the end of the acceleration over at least one period of a current and/or torque oscillation.

A preferred procedure is characterized in that the speed reference profile is calculated by mathematical convolution of the operator signal provided by the operator, with a frequency elimination signal suppressing vibrations at the natural frequency of the structure of the crane system, wherein the frequency elimination signal is derived in real time from the determined natural frequency and the damping ratio.

The desired speed reference profile is generated by convolution of the user-defined speed command which originates from the operator, with the frequency elimination signal which cancels vibrations at the natural frequency of the crane structure. The result of this convolution operation is the speed reference signal which does not excite any vibrations at the natural frequency of the system, and thus allows a soft pivoting movement of the jib.

According to a particularly preferred procedure, is provided that the frequency elimination signal comprises two time-delayed pulses each having an amplitude, wherein the pulses are mutually time-delayed by a time t where

$$t = \frac{1}{2 f \sqrt{1 - {ζ}^{2}}}$$

where f is the calculated natural frequency and ζ the calculated damping ratio.

Numerous signals exist that satisfy the requirements for cancellation of the vibrations at a given frequency of a system, wherein the simplest signal is represented by time-delayed pulses. This signal is used because it yields the shortest acceleration and delay ramps—one of the most important criteria for the operator.

It is preferable for the operator to use a square-wave signal or a trapezoidal signal as operator signal.

The speed profile for controlling the drive or swivel motor is modified in such a manner that said profile is adapted to the mechanical frequency characteristics of the structure, so that fewer stresses act on the structure, fewer disturbances occur, and a stable speed of the crane jib is achieved. In contrast to the known methods, which prefer the use of a V (voltage)/F (frequency) motor control or another method for limiting the torque, the motor control does not “fight” the crane structure, rather it controls the motor in an optimal manner. In known methods, the motor speed can only be influenced by the torque generated by torsion of the structure, in order to smooth the movement.

The use of active profile generators requires the specification of system parameters such as the natural frequency and the damping ratio. It is possible to carry out a measurement of frequencies of the crane structure and its damping ratio using additional sensors. However, this approach requires additional hardware which reduces the simplicity, and the costs of this solution would be higher.

It is preferable to provide that the system parameters are calculated continuously during the operation of the rotating tower crane, and that, in the case of a change of the mechanical properties of the structure, an adaptation of the speed reference profile occurs.

It is preferable for the configuration algorithm to be capable of being applied even during the usual operation of the machine, and of changing the system parameters of the speed generator, for example, if there is a change in the mechanical properties of the system. This can occur by on-the-fly detection of increasing vibrations and measurement of the frequency.

The software for carrying out the method is implemented in a SoMachine (registered trademark) software program and developed in such a manner that it can run on a PC which supports 32-bit floating point mathematics. The function or the method must be carried out in a periodic cycle. The control algorithm is implemented at discrete times. The implementation period is used for calculating the speed reference profile. The method can be used in the case of variable speed drive units, which are capable of precisely following the speed reference profile in vector control modes.

The described method allows the automatic configuration of speed profile generators that require the natural frequency and the damping ratio as input parameters.

Using the method, there is no need to configure parameters which would be difficult to determine without additional equipment. Thus, the commissioning/startup of the optimal pivoting movement of rotating tower cranes is simplified.

A control device is characterized in that the control device comprises a measuring device for determining a vibration course implicitly containing the natural frequency f_{EIG} and the damping ratio ζ of the crane element, in particular of a motor current and/or of a motor torque, as well as a parameter calculation unit connected to said device for the real-time calculation of the system parameters in the form of the natural frequency as well as the damping ratio from the determined measurement values, particularly the current values and/or torque values, in that the parameter calculation unit is connected to the set value calculation unit designed as a speed reference profile generator, in which unit the control signal can be calculated as an active speed reference profile from the input signal provided by the operator, taking into account the natural frequency and damping ratio of the crane system determined in real time.

The measuring device can be designed as a current/torque device or as a vibration sensor.

In a preferred embodiment, it is provided that the parameter calculation unit comprises a spectral analyzer, such as a calculation unit designed as a fast Fourier transform unit, and in that an outlet of the calculation unit is connected to a calculation unit for the calculation of the system parameters, natural frequency and damping ratio.

In the calculation unit designed as a spectral analyzer, the determined measurement values are analyzed by fast Fourier transform, wherein a dominant frequency in the spectrum of the current/torque course is determined preferably by comparison with provided mean values.

Moreover, it is provided that an outlet of the set value calculation unit is connected to a motor control, and that the motor control is designed as an open loop control, comprising a speed regulator, a preferably secondary torque/current regulator as well as the measuring device, wherein the motor current and/or the motor torque is/are fed back via an adding element arranged between the speed regulator and the torque/current regulator into the torque/current regulator.

The motor control moreover comprises a speed estimation element, which derives, from the current/torque values determined in the measuring device, a speed actual value, which is linked to the speed reference profile and fed to the speed regulator.

It is preferable for the operator signal to be connected via a modification unit to the set value calculation unit.

The method has the advantage that the drive or pivoting motor of the crane is controlled in an optimal manner, wherein the energy introduced into the structure is not wasted for generating vibrations, but is used for executing a sleek, smooth pivoting movement.

The following advantages are achieved by means of the method according to the invention:
a soft, oscillation-free movement of the jib,
reduced stresses on the structure,
a reduction of noises generated during the movement,
the entire torque is available for driving the jib,
a significant, energy-efficient reduction of energy wasted by the oscillation.

Further details, advantages and characteristics of the invention result not only from the claims, the characteristics that can be taken from them—separately and/or in combination—, but also from the following description of the preferred embodiment examples that can be seen in the figures.

FIG. 1a shows a diagrammatic representation of a rotating tower crane,

FIG. 1b shows the course of a set and an actual angular speed versus time of a crane jib,

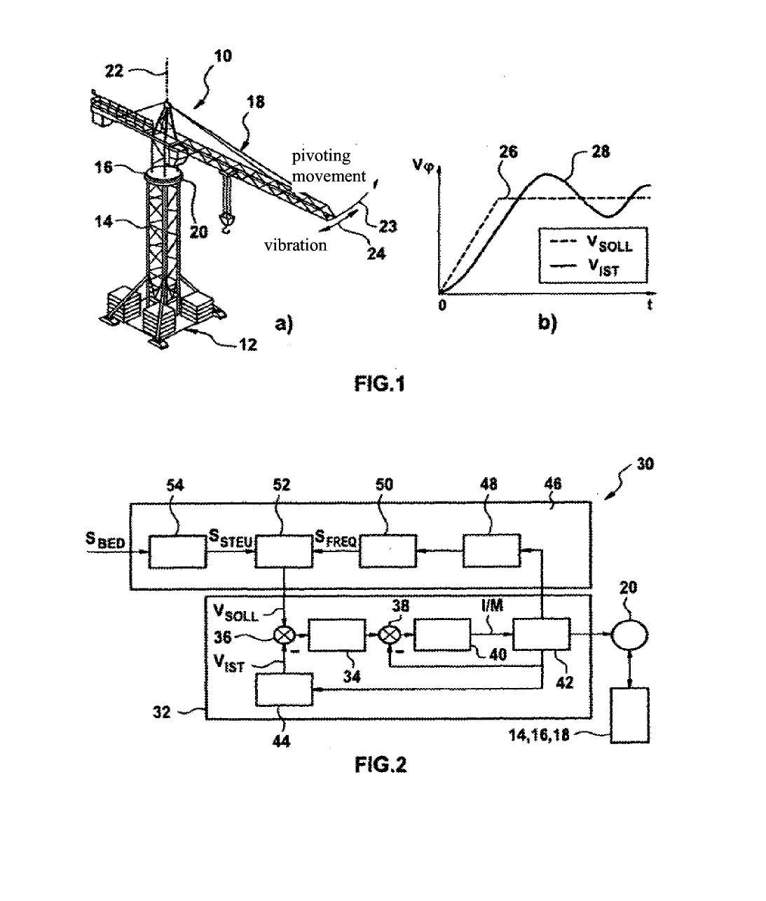

FIG. 2 shows a diagrammatic representation of a control system,

FIG. 3 shows a representation of speed profiles versus time,

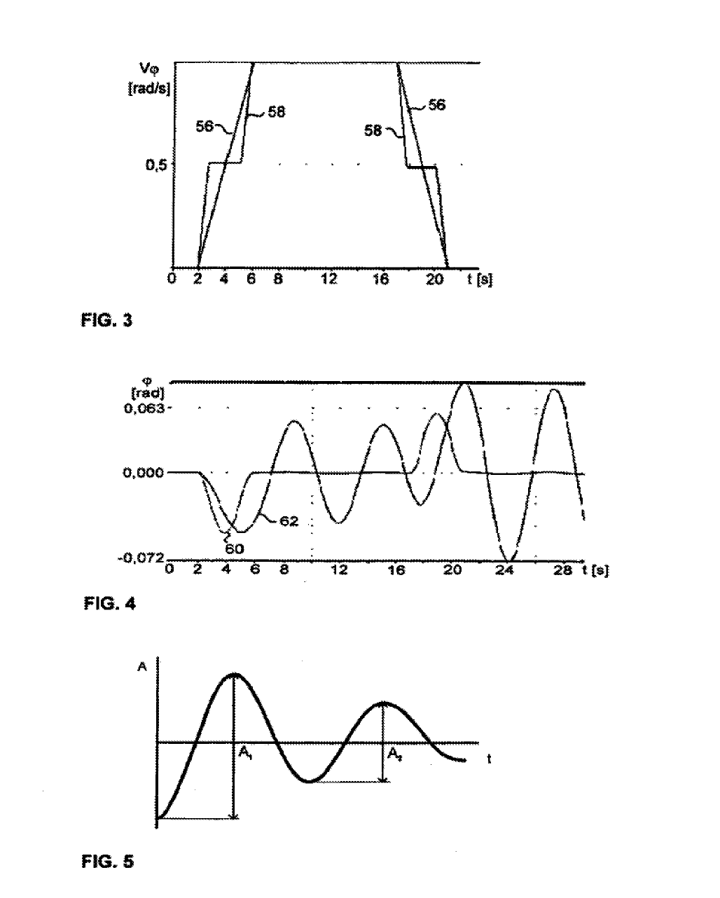

FIG. 4 shows a representation of vibration deflections versus time,

FIG. 5 shows a decaying vibration,

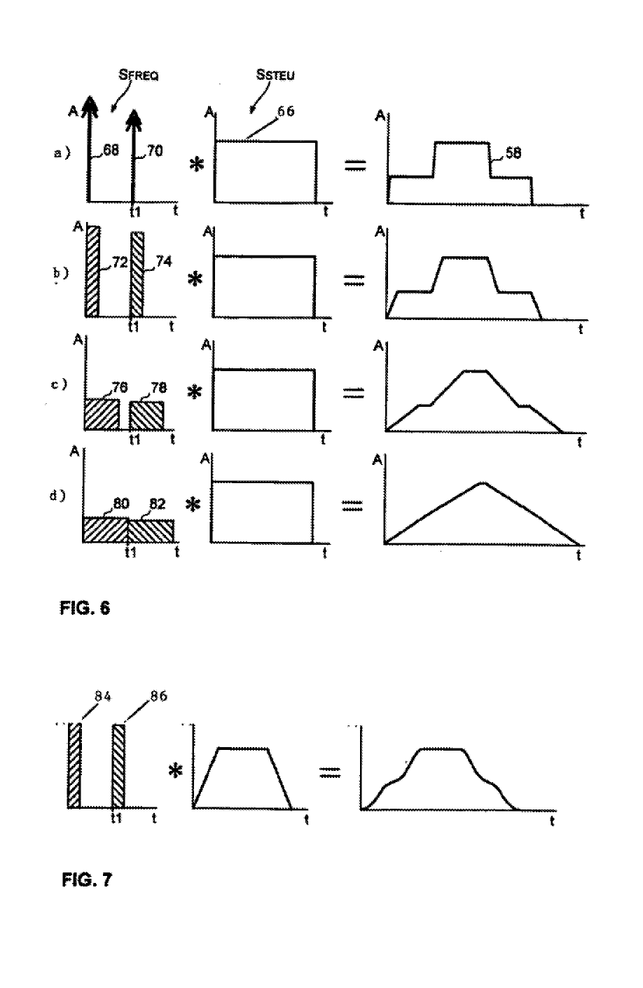

FIGS. 6a)-d) show speed set profiles as the result of a convolution of an operator pulse with a ramp function,

FIG. 7 shows a speed profile as the result of a convolution of an input pulse with a ramp function with linear increasing ramp,

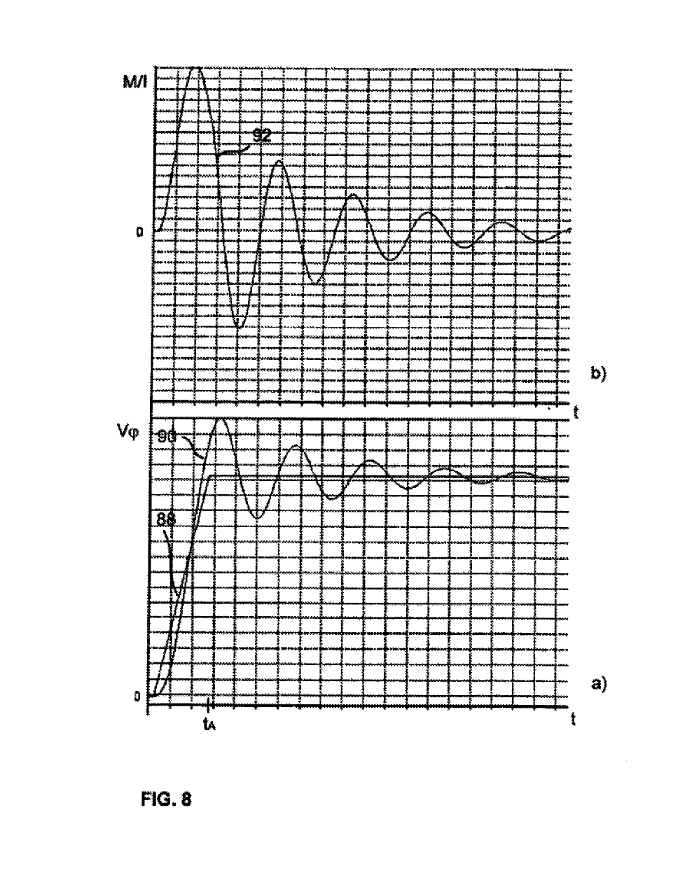

FIGS. 8 a), b) show a speed profile with rising ramp, the resulting speed profile of a crane jib as well as the current/torque course of the drive motor,

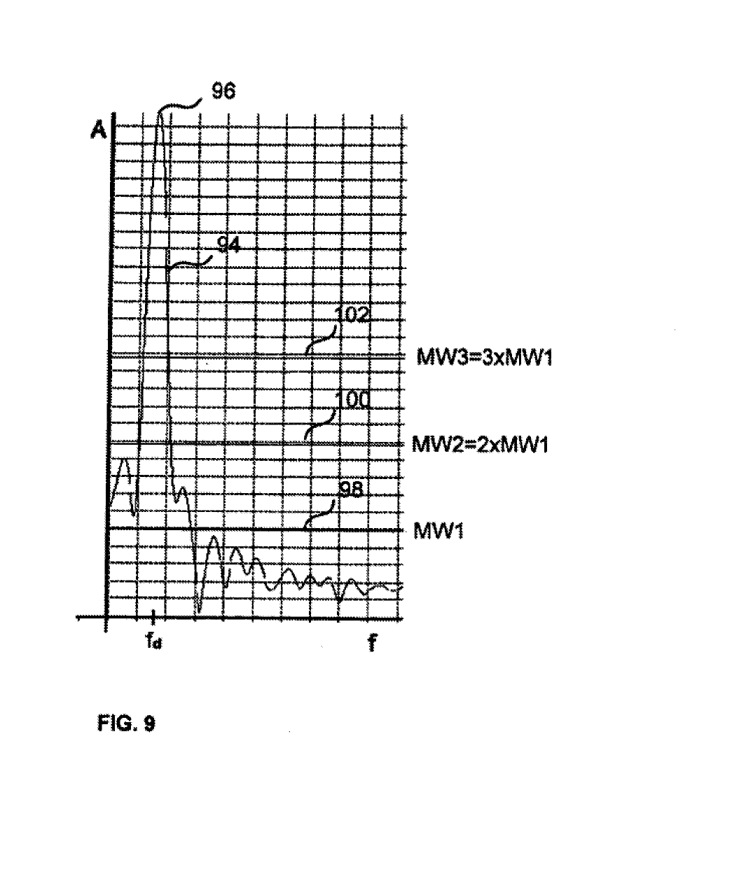

FIG. 9 shows a spectral distribution of the torque/current course according to FIG. 8b),

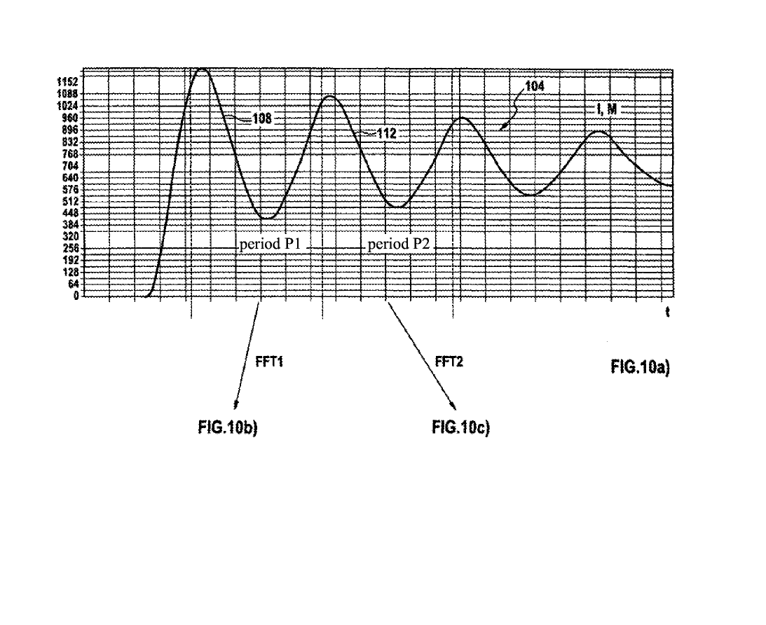

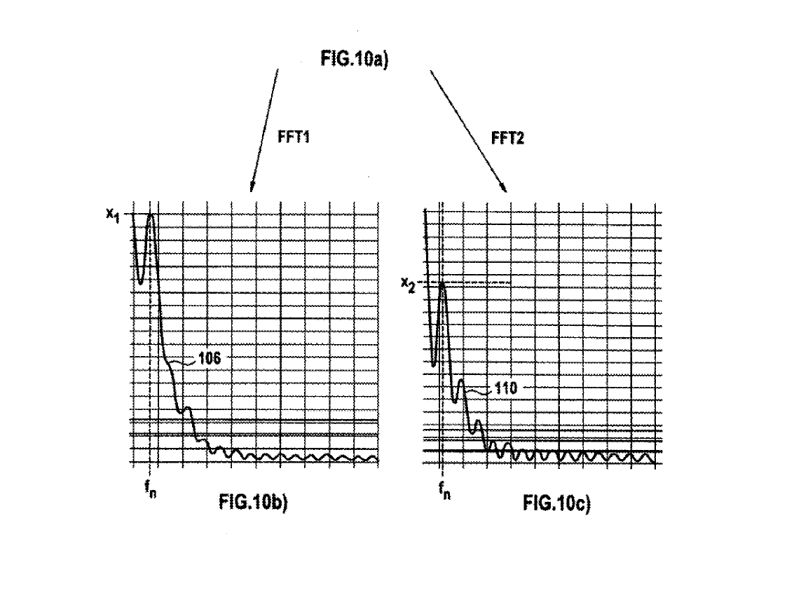

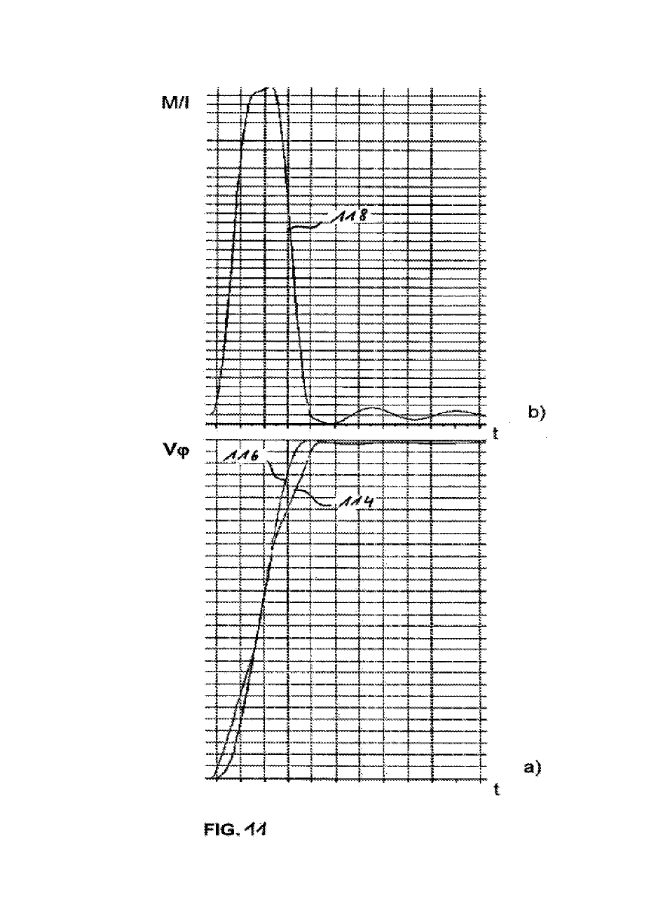

FIG. 10a) shows a torque/current course of the drive motor,

FIGS. 10b)-c) show spectral distributions of time sections of the torque/current course according to FIG. 10a),

FIGS. 11a), b) show a modified speed profile with the resulting speed course of the crane jib and the torque/current course of the motor, and

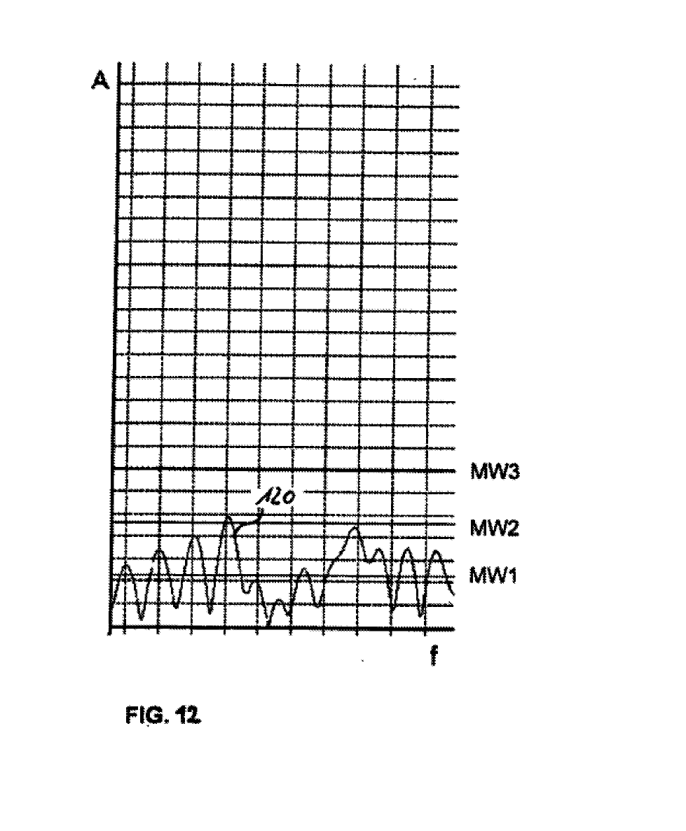

FIG. 12 shows a spectral distribution of the torque/current course according to FIG. 11b).

FIG. 1a shows purely diagrammatically a flexible, mechanical structure of a crane system, such as a rotating tower crane 10, comprising a tower 14 originating from a base 12, tower on which a jib 18 is mounted rotatably via a pivot 16. The jib 18 can be pivoted by means of an electric motor 20 about a pivot shaft 22 in the direction of the arrow 23. The energy stored in the flexible structure of the rotating tower crane 10, during an acceleration or deceleration process, causes vibrations in the mechanical structure which are marked with the reference numeral 24. The vibrations which are superposed on a pivoting speed of the crane jib 18 are perceived by a crane operator, for example, as an unstable speed of the jib end.

FIG. 1b shows the course of a desired set speed V_{SOLL} according to curve 26 and of an actual speed V_{IST} according to curve 28.

The mechanical structure of the rotating tower crane 10 behaves as a spring during the pivoting movement. The energy delivered by the engine 20 results in a torsion of the tower 14 and of the jib 18. The energy stored in the mechanical structure causes fluctuations of the actual speed 28, as represented in FIG. 1b.

FIG. 2 shows purely diagrammatically a control device 30 for the low-vibrational control of the crane jib 18 or of the tower 14 of the rotating tower crane 10 by means of the motor 20.

The control device 30 comprises a motor control 32 having a speed regulator 34 to which, on the input side, via an adding element 36, a speed set value V_{SOLL} as well as a speed actual value V_{IST} is applied.

The speed regulator 34 is connected on the output side via an adding element 38 to a current/torque regulator 40 which, on the output side, delivers current/torque values I/M for controlling the motor 20. The current/torque values I/M are determined by means of a measuring device 42, and they are applied, in the form of a regulation circuit, on the one hand, to the adding element 38, and, on the other hand, to a speed estimation device 44 which provides the speed actual value V_{IST} for the adding element 36.

By means of the described speed and current regulation circuits, a variable motor control 32 with variable speed is made available.

According to the invention, by means of the measuring device 42, values corresponding to or proportional to a torque M of the motor 20, such as current values of the motor 20, are determined, and fed to a speed profile generation and identification unit 46. The speed profile generation and identification unit 46 comprises a spectral analysis unit, such as a fast Fourier transform unit 48, in which the acquired measured values are subjected to a spectral analysis, such as a fast Fourier transform. Then, the analyzed values are fed to a calculation unit 50, in which the system parameters, such as the natural frequency f_{EIG} and/or the damping ratio ζ of the crane system 10 is/are calculated. The calculated system parameters are used as a first input variable for a speed profile generator 52. A control command S_{BED} of a crane operator or an operator is applied optionally with prior adaptation through a modification unit 54 to the speed profile generator 50 as second input variable.

From the system parameters and the control command S_{BED} of the crane operator, a speed profile for the speed target set value V_{SOLL} is then calculated.

The use of a speed profile generator 52 for the low-vibrational control of a motor 20 is sufficiently known from the prior art.

However, according to the invention, an automatic calculation of the system parameters occurs, based on values of the instantaneous motor current I and/or motor torque M, which are determined by means of the measuring device 42 during the operation.

In the process, the fact that the motor torque M and consequently the motor current I vibrate at the same frequency as the mechanical structure of the rotating tower crane 10 is exploited. Consequently, it is possible to derive system parameters of the mechanical structure; in particular, the natural frequency f_{EIG} and the damping ratio ζ can be derived using the sampled current/torque profile.

FIG. 3 shows two speed profiles 56, 58 for the speed set value V_{SOLL}, wherein the speed profile 56 represents a linear ramp and the speed profile 58 represents a step-shaped ramp having the same duration. In the time interval from 2 s to 6 s, an acceleration is represented, and in the time interval from 16 s to 21 s, a deceleration is represented.

For the speed profiles 56, 58 represented in FIG. 3, vibration courses 60, 62 of the speed of one end of the jib 18 are represented correspondingly in FIG. 4, wherein the vibration course 60 results from the control with the speed ramp 58 and the vibration course 62 results from the control with the speed profile 56.

The above vibration courses 60, 62 illustrate that the speed ramp 58 generates fewer vibrations in the mechanical structure than, for example, the control with the speed ramp 56.

The desired speed reference profile 58 is generated by mathematical convolution of a control signal S_{STEU} generated from the control command S_{BED}, with a frequency elimination signal S_{FREQ} which cancels vibrations at the natural frequency of the crane structure. If the motor 20 is controlled with the speed reference profile 58 as speed set value V_{SOLL}, no vibrations are generated at the natural frequency of the mechanical structure, and thus a soft pivoting movement of the jib 18 becomes possible.

Numerous frequency elimination signals S_{FREQ} exist, which satisfy the requirement of the cancellation of vibrations at a given natural frequency of the structure, wherein a simple signal S_{FREQ} comprises two pulses 68, 70; 72, 74; 76, 78; 80, 82; 84, 86 time-delayed by the time t₁. The pulses can have varying amplitudes A and time periods Δt, as represented in FIGS. 6a)-6d).

The frequency elimination signal S_{FREQ}, as explained above, consists of two pulses, for example, pulses 68, 70. The first pulse 68 is generated at time t=0 s, in order to keep the total length of the modified acceleration and deceleration ramp as short as possible. The second pulse 70 is time-delayed by the time t₁, which depends on the natural frequency f_{EIG} of the crane structure 10 and its damping ratio ζ.

The time t for setting the second pulse corresponds to half the period of a vibration at the natural frequency f_{EIG} of the crane structure, compensated by the damping ratio ζ.

$$t = \frac{1}{2 f \sqrt{1 - {ζ}^{2}}}$$

where f is the natural frequency [Hz] of the crane structure and ζ is the damping ratio.

The damping ratio ζ defines the damping of a vibration according to FIG. 5 at the natural frequency f_{EIG}. For the calculation of the damping ratio ζ, the logarithmic decrement δ is needed, which is defined as the logarithm of the ratio of two consecutive amplitudes A₁, A₂:

$$δ = ln \frac{{x}_{1}}{{x}_{2}}$$

The formula for calculating the damping ratio ζ is:

$$ζ = \frac{δ}{\sqrt{{( 2 π )}^{2} + {δ}^{2}}}$$

The relation between the amplitudes A1, A2 of pulses is:

$$\frac{{A}_{2}}{{A}_{1}} = {e}^{\frac{- ζ π}{\sqrt{1 - {ζ}^{2}}}}$$

The amplitudes A1, A2 of the two pulses have to add to the sum 1 in order to reach, for the generated control command, the value for the unformed control command.

A₁+A₂=1.

The resulting pulse sequence is then convolved with a conventional control signal.

$$( f * g ) = {\int }_{0}^{t} f ( τ ) g ( t - τ ) d τ$$

f=control command of the operator

g=precalculated pulse sequence.

The natural frequency f_{EIG} of the flexible system 10 is a frequency at which the mechanical structure of the rotating tower crane 10 vibrates, if kinetic energy acts on the structure (for example, if the structure is accelerated). The optimal method for measuring the frequency depends on the measuring system. The simplest way is to count the vibrations over a time period. The frequency can then be calculated using the following formula:

f_{EIG}=number of vibrations/time period [Hz]

Here T is the period duration of a vibration at the natural frequency f_{EIG}.

The natural frequency f_{EIG} of the structure of the rotating tower crane 10 can be determined in a simplified manner as follows:
setting of the motor control 32 to acceleration using a linear acceleration ramp which is sufficiently steep in order to generate noticeable vibrations in the structure;
specification of a control command for pivoting the jib 18 at a low speed and active stopping of the control command;
determination of the vibrations of the system by means of vibration sensors and identification of a characteristic repetition behavior corresponding to several vibration phases of signals, such as noise, vibration, torque/motor current peaks;
counting events corresponding to the number of vibrations and measuring the associated time; and
calculating the natural frequency using the above formula.

Simple pulses, which are defined in the theory of input shaping, have been broadened in this implementation to a variable length (FIGS. 6a)-6d)). It is possible to influence the duration of the acceleration/deceleration phase, of the acceleration, and the amount of vibration by modifying the pulse length. The need for the amplitudes A1, A2 of the two pulses to add up to the sum 1 leads to the requirement that the sum of the areas under the pulses also must be 1.

FIG. 6 shows the influence of the shape of the calculated pulses 68, 70; 72, 74; 76, 78; 80, 82 on the output speed reference profile 58. The surface area of the pulses and the time t of the second pulse are dependent on the natural frequency f_{EIG} and on the damping ratio ζ of the structure and they are constant in the four examples. The figures show that the pulses of short duration and larger amplitude increase the steepness of the acceleration and, also (to some extent) shorten the duration of the transition phase. An optimal setting with balanced steepness of the ramp and its duration is dependent on the mechanical properties of the crane 10.

The speed reference profiles represented in FIG. 6 are suitable to suppress vibrations at defined frequencies. However, a profile which leads to an excessive number of “jerks” can excite higher vibration modes of the system.

FIG. 7 shows the use of a linearly increasing control signal S_{STEU} instead of a steep signal. This control signal S_{STEU} is generated by modifying the operator signal S_{BED} in the unit 52. The algorithm for the convolution the control signal S_{STEU} 68, 70; 72, 74; 76, 78; 80, 82 and the pulse sequences 66 is implemented in the time domain for practical reasons and it uses the discrete form of a convolution integral which in itself is known.

A further preferred auto-configuration method for the rotating tower crane 10 has the following process steps:
performing a movement of the crane jib 18 about the pivot shaft 22 by means of the motor 20 using an arbitrary or user-defined speed profile 56, 88 as acceleration ramp according to FIG. 3 or FIG. 8a), which is sufficiently steep to excite a vibration in the mechanical structure of the rotating tower crane 10,
sampling of torque M and/or current values I of the motor 20,
performing a spectral decomposition, such as fast Fourier transform of the current values I and/or torque values M determined by means of the measuring device 42,
identifying the dominant frequency f_{d} of the spectrum of the transformed values in the calculation unit (48),
calculating the natural frequency f_{EIG} of the mechanical structure 10,
using the natural frequency f_{EIG} and the originally sampled torque data and/or current data for the calculation of the damping ratio ζ of the mechanical structure of the rotating tower crane 10,
preferably regular repetition of the described process steps using the acceleration ramp determined in the respective previous cycle.

The sampling of the torque values and/or current values starts at time t_{A}, when the acceleration ramp ends, i.e., when the system is no longer accelerated and vibrates freely.

The preferred auto-configuration procedure is explained in further detail below. One possible speed profile 88 of a speed set value V_{SOLL} for controlling the motor 20 is shown purely diagrammatically in FIG. 8a. The speed profile 88 is proportional to an angular speed of a motor shaft at the time of the control with a linear ramp. Here, it should be noted that the true angular speed of the motor is much higher and shown at reduced scale for the purpose of the representation. The curve 90 according to FIG. 8a shows the angular speed of an end of the crane jib 18 in the form of a decaying vibration.

FIG. 8b shows a current-torque course 92 which is determined by means of the measuring device 42. Said course has the course of a decaying vibration as well. The current values and torque values I/M are sampled and subjected to a spectral analysis by means of a fast Fourier transform in the calculation unit 48. An energy spectrum 94 of the current or torque course 92 is represented in FIG. 9. The energy spectrum has a maximum 96 at a dominant frequency f_{d}. Furthermore, mean value lines 98, 100, 102 are included in the drawing to represent the mean values MW1, MW2, MW3, where the mean value MW2 corresponds to twice the value of the mean value MW1 and the mean value MW3 to three times the mean value MW1. The mean values MW2, MW3 represented by the mean value lines 100, 102 can be used in order to determine whether a dominant frequency f_{d} is contained in the spectrum 94. For example, the dominant frequency f_{d} must have an amplitude A which corresponds at least to the mean value MW3, and none of the amplitudes of the other frequencies should be equal to or greater than the mean value MW2.

The dominant frequency f_{d} determined in this manner corresponds to the natural frequency f_{EIG} of the mechanical structure of the rotating tower crane 10.

Furthermore, from the course 92 of the current values/torque values I/M, the damping ratio ζ can be determined on the basis of the decaying amplitude values.

Alternatively, the natural frequency f_{EIG} can be determined taking into account the following conditions:
the amplitude of the dominant or identified frequency f_{d} must be greater than the mean value MW1,
the identified or dominant frequency f_{d} must be within a frequency band which is plausible for a rotating tower crane, wherein empirically determined limits are in the range of approximately 0.03 Hz≦f_{d}≦0.25 Hz, and
the identified or dominant frequency f_{d} must satisfy the conditions of the Nyquist-Shannon theorem, i.e., the frequency must be smaller than ½×the sampling period and greater than 1/total sampling time.

From the course 92 of the current values/torque values I/M, the damping ratio ζ can be determined based on the maximum and minimum amplitudes of the decaying amplitude values taking into account the mean values of the drive torque.

Alternatively, the damping ratio ζ can be represented by means of Fourier transforms FFT1, FFT2 of two consecutive time segments having a length of one period P1, P2 of the natural frequency. The process is represented in FIGS. 10a)-10c).

FIG. 10a) shows a vibration course 104 of the torque/motor current M, I versus time t. A course 106 of a Fourier transform FFT1 of a section 108 of the first period P1 is represented in FIG. 10b) with respect to the frequency f. FIG. 10c) shows a course 110 of a section 112 of the period P2 of the torque signal/current signal M, I. The values of the amplitude maxima x₁, x₂ of the two spectra 106, 110 at the nominal frequency or dominant frequency fₙ are used for the calculation of the logarithmic decrement

$$δ = ln \frac{{x}_{1}}{{x}_{2}}$$

and finally for the calculation of the damping ratio

$$ζ = \frac{δ}{\sqrt{{( 2 π )}^{2} + {δ}^{2}}} .$$

Next, from the natural frequency f_{EIG} and the damping ratio ζ, the frequency elimination signal S_{FREQ}, in particular the time shift t between the individual pulses can be calculated. Together with the control signal S_{STEU} the speed profile 58 according to FIG. 3 is subsequently calculated in the speed profile generator 52, or 114 according to FIG. 11a), in accordance with the input variables. A correspondingly calculated speed profile 114 is represented in FIG. 11a). A resulting speed course 116 of the end of the crane jib 18 according to FIG. 11a) shows that vibrations have been eliminated. The same applies to the current/torque course which is represented by the curve 118 in FIG. 11b). In comparison to the curve 92 according to FIG. 8b), the curve 118 now has only slight vibrations.

FIG. 12 shows a spectrum 120 of the current/torque course 118 according to FIG. 11d, from which it can be seen that it contains no dominant frequencies, because they were eliminated by using the modified acceleration ramp 114.

It should be noted that the sampling of the current/torque values starts when the acceleration ramp 114 has ended. This condition is used in order to measure the true natural frequency and filter out vibrations due to forced frequencies that are caused by the acceleration ramp.

During the usual operation of the rotating tower crane 10, the speed profile and identification unit 46 executes a configuration algorithm, so that the system parameters for the speed profile generator 52 can be determined during operation, if, for example, mechanical properties of the rotating tower crane 10 change.

This can occur by the on-the-fly determination of increasing vibrations and measurement of the frequency. Consequently, the method according to the invention allows the automatic configuration of the speed profile generator 52, which requires the natural frequency f_{EIG} and the damping ratio ζ of the rotating tower crane 10 as input parameters.

Consequently, the known configuration of system parameters, the determination of which would cause additional equipment problems, which is necessary in the prior art before the startup, is dispensed with. In addition, the startup of rotating tower cranes is simplified.

The desired functions generate a speed profile for the control of the motor 20. The speed profile is calculated in such a manner that active vibrations at the natural frequency of the crane structure are suppressed.

The advantage of using this function is that the pivoting movement of the crane structure is executed in an optimal manner, wherein the energy introduced into the structure is not used up by vibrations; instead it results in a uniform, energy-efficient pivoting movement.

1. Method for the low-vibrational control of the movement, by means of a motor (20), of a moveable crane element (14, 16, 18), such as a crane jib (18) of a crane system (10), which can be made to vibrate at a natural frequency (f_{EIG}) and which has a damping ratio (c), wherein the moveable crane element (14, 16, 18) is controlled by a control signal (V_{SOLL}) whose spectrum is substantially free of natural frequencies (f_{EIG}) of the crane system (10), wherein the control signal (V_{SOLL}) is calculated from an operator signal (S_{BED}) of an operator taking into account system parameters of the crane system (10),
characterized in that
the system parameters are automatically calculated during the operation in the form of the natural frequency (f_{EIG}) as well as the damping ratio (ζ) of the crane system (10), and in that the control signal (V_{SOLL}) is calculated as active speed reference profile (V_{SOLL}) in real time from the operator signal (S_{BED}) of the operator and from the calculated natural frequency (f_{EIG}) and the damping ratio (ζ) of the crane system (10).

2. Method according to claim 1,
characterized in that
the natural frequency (f_{EIG}) and the damping ratio (ζ) of the crane system (10) are calculated from a measured current (I) and/or torque (M) of the motor (20).

3. Method according to claim 1,
characterized in that
the system parameters are determined according to the following process steps:
a) executing a first movement of the moveable crane element (18) by accelerating the crane system by means of a freely selectable speed profile (56, 88), such as an acceleration ramp with linear course, which is steep enough to make the crane system (10) vibrate,
b) sampling of torque values and/or current values (M/I),
c) performing a spectral analysis preferably by discrete fast Fourier transform with the determined torque values and/or current values and determining a spectral distribution (94),
d) identifying a dominant frequency (f_{d}) of the spectral distribution (94) as the natural frequency (f_{EIG}) of the crane system, and
e) calculating the damping ratio (ζ) from the originally sampled current values and/or torque values.

4. Method according to claim 1,
characterized in that
the sampling of the torques and/or current values (M/I) occurs after the completion of the acceleration over at least one period.

5. Method according to claim 1,
characterized in that
the speed reference profile (V_{SOLL}) is calculated by mathematical convolution of the operator signal (S_{BED}) provided by the operator with a frequency elimination signal (S_{FREQ}) which suppresses vibrations at the natural frequency (f_{EIG}) of the structure of the crane system (10), wherein the frequency elimination signal (S_{FREQ}) is derived in real time from the determined natural frequency (f_{EIG}) and the damping ratio (ζ).

6. Method according to claim 1,
characterized in that,
as operator signal (S_{BED}), the operator uses a square-wave signal or a trapezoidal signal.

7. Method according to at least one of the previous claims,
characterized in that
the frequency elimination signal (S_{FREQ}) has two time-delayed pulses (68, 70; 72, 74; 76, 78; 80, 82; 84, 86) each with an amplitude (A1, A2), wherein the pulses are mutually time-delayed by a time t, where
$$t = \frac{1}{2 f \sqrt{1 - {ζ}^{2}}}$$
where f is the calculated natural frequency (f_{EIG}) and ζ is the calculated damping ratio (ζ).

8. Method according to claim 1,
characterized in that
the system parameters are calculated continuously in the form of the natural frequency (f_{EIG}) as well as the damping ratio (ζ) during the operation of the crane system (10), and in that, in the case of a change in the mechanical properties of the structure, an adaptation of the speed reference profile (V_{SOLL}) occurs.

9. Method according to claim 1,
characterized in that
the calculation of the system parameters in the form of the natural frequency (f_{EIG}) as well as of the damping ratio (ζ) is carried out in a periodic cycle in discrete time sections, wherein an execution period of the speed reference profile (V_{SOLL}) is used for the calculation.

10. Method according to claim 1,
characterized in that,
for identifying the dominant frequency (f_{d}) of the spectral distribution (94), a maximum (96) of the spectral distribution (94) is determined, wherein the maximum (96) must be at least three times the mean value (MW1) of the spectral distribution (94), and wherein none of the other frequencies should have an amplitude that is greater than twice the mean value (MW1) of the spectral distribution (94).

11. Method according to claim 1,
characterized in that
the dominant frequency (f_{d}) of the spectral distribution (94) is determined according to the following conditions:
the amplitude of the dominant frequency (f_{d}) must be greater than the mean value (MW1),
the dominant frequency (f_{d}) must be within a frequency band which is plausible for the crane system (10), preferably in the range of approximately 0.03 Hz≦f_{d}≦0.25 Hz,
the dominant frequency (f_{d}) must satisfy the conditions of the Nyquist-Shannon theorem, i.e., the frequency must be smaller than ½×sampling period and greater than 1/total sampling time.

12. Method according to claim 1,
characterized in that
the damping ratio (ζ) is calculated according to the formula
$$ζ = \frac{δ}{\sqrt{{( 2 π )}^{2} + {δ}^{2}}} , \\ where$$
$$δ = ln \frac{{A}_{1}}{{A}_{2}}$$
where A1, A2 are maximum and minimum amplitude values (A1, A2) of the decaying torque/current course, and in that the calculation occurs preferably taking into account the mean values of the drive torque, wherein the calculation is carried out in the time domain.

13. Method according to claim 1,
characterized in that
the damping ratio (ζ) is determined by Fourier transform (FFT1, FFT2) of two consecutive time segments having a length of a period (P1, P2) of the current/torque course (I, M), wherein, from the Fourier transform (FFT1) of the first period (P1), a spectral distribution (106) having a maximum (x1) is determined, wherein, by means of the Fourier transform (FFT2) of the second period (P2), a spectral distribution (110) having a maximum (x2) is determined, wherein the amplitude maxima (x1, x2) of the spectral distribution (106, 110) are at the dominant frequency (fₙ), wherein the logical decrement is calculated using the formula
$$δ = ln \frac{{x}_{1}}{{x}_{2}}$$
and the damping ratio (ζ) is calculated using the formula
$$ζ = \frac{δ}{\sqrt{{( 2 π )}^{2} + {δ}^{2}}} .$$

14. Method according to claim 1,
characterized in that
the motor (20) is controlled with variable speed in the vector control mode.

15. Control device (30) for the low-vibrational control of the movement of a moveable crane element (14, 16, 18), such as a crane jib (18) of a crane system (10), which can be made to vibrate at a natural frequency (f_{EIG}) and which has a damping ratio (c), wherein the moveable crane element (18) can be controlled with a control signal (V_{SOLL}) whose spectrum is essentially free of the natural frequency (f_{EIG}), wherein the control signal (V_{SOLL}) is calculated in a set value calculation unit (52) from an operator signal (S_{BED}) of an operator taking into account system parameters, and wherein the control signal (V_{SOLL}) applied to the outlet of the set value calculation unit (52) is fed to a motor control (32) for the control of the motor (20),
characterized in that
the control device (30) comprises a measuring device (42) for determining a vibration course (62, 92, 90) implicitly containing the natural frequency (f_{EIG}) and the damping ratio (ζ) of the crane system as well as a parameter calculation unit (48, 50) connected to the former device, for the real-time calculation of the system parameters in the form of the natural frequencies (f_{EIG}) and the damping ratio (ζ) from the determined measured values (I, M), in that the parameter calculation unit (48, 50) is connected to the set value calculation unit (52) designed as a speed reference profile generator, in which calculation unit the control signal can be calculated as active speed reference profile (V_{SOLL}) from the input signal provided by the operator, taking into account the natural frequency (f_{EIG}) and damping ratio (ζ) of the crane system (10) determined in real time.

16. Control device according to claim 15,
characterized in that
the measuring device (42) is designed as a measuring device which determines the motor current (I) or the motor torque (M).

17. Control device according to claim 15,
characterized in that
the measuring device (42) comprises vibration sensors for determining the vibration of the mechanical structure of the crane system (20).

18. Control device according to claim 15,
characterized in that
the parameter calculation unit (48, 50) comprises a calculation unit (48) designed as a spectral analyzer, such as a fast Fourier transform unit, and in that an outlet of the calculation unit (48) is connected to a calculation unit (50) for the calculation of the system parameters, natural frequency (f_{EIG}) and damping ratio (ζ).

19. Control device according to claim 15,
characterized in that
an outlet of the set value calculation unit (52) is connected to a motor control (32), in that the motor control (32) is designed as an open loop control comprising a speed regulator (34), a preferably subordinate torque/current regulator (40) as well as the measuring device (42), wherein the motor current and/or the motor torque are fed back via an adding element (38), arranged between the speed regulator and the torque/current regulator (40), into the torque/current regulator (40).

20. Control device according to claim 15,
characterized in that
the motor control (32) comprises a speed estimation element (44) which derives a speed actual value (V_{IST}) from the current-torque values determined in the measuring device (42), actual value which is linked to the speed reference profile (V_{SOLL}) and fed to the speed regulator (34).

21. Method according to claim 15,
characterized in that
the operator signal (S_{BED}) is connected via a modification unit (54) to the set value calculation unit (52).
